(19) United States
(12) Patent Application Publication
(10) Pub. No.: US 2004/0010415 A1
(43) Pub. Date: Jan. 15, 2004

(54) Apparatus and method for searching digital audio data file from media where digital audio data files are recorded

(76) Inventors: Yoon-Deuk Seo, Seoul (KR); Burn-Ho Seo, Seoul (KR); Bong-Ja Choi, Kyoung-gi (KR); Suk-Jin Hong, Inchon (KR); Han-Kyo Kim, Seoul (KR); Seung-Jeong Park, Seoul (KR)

Correspondence Address: David L Tarnoff, Shinjyu Global IP Counselors, Suite 700, 1233 Twentieth Street NW, Washington, DC, 20036, US

(21) Appl. No.: 10/031,857

(22) PCT Filed: Dec. 23, 2000
(86) PCT No.: PCT/KR00/01529

(30) Foreign Application Priority Data
Feb. 23, 2000 (WO) PCT/KR00/00144

(51) Int. Cl. G10L 19/00

(52) U.S. Cl. 704/500

(57) ABSTRACT

The present invention relates to an apparatus and method for searching a digital audio data file from a media where digital audio data files are recorded. The media comprises a directory information recording area and data recording area where information on the files listed in the directory recording area is recorded. The digital audio data file has a file name field, a data field, and an additional information tag field. The file name field, and the data field and additional information tag field is recorded on the directory information recording area and the data recording area, respectively. Further, recording indexing information which is used as a keyword for searching the digital audio data file is recorded on the directory information recording area. The present invention employs a method for making a database structure comprising the steps of: making a directory database having fields of directory names and the position of each directory on the directory information recording area; making a file database having fields of file names and the position of each file on the data recording area by accessing the directory information recording area; and recording the indexing information in the file database as an additional field.

### TECHNICAL FIELD

The present invention relates to a digital audio data recording/playing system. In particular, the invention is directed to a digital audio recording/playing system that can search digital audio data that is recorded in recording media, at high speed.

### BACKGROUND ART

Compact disc player has been widely distributed as digital audio playing system. A compact disc can store audio date of about 650 Mb. Such a compact disc can record digital audio date of seventy two (72) minutes if the audio data is in WAV format that samples analog audio data with 44.1 KHz. Thus, generally, the compact disc may record digital audio data up to a maximum of twenty (20) pieces of music, assuming that each of the music is played during about four (4) minutes. The display of the compact disc playing system shows serial numbers of the recorded digital audio data. The user can select the serial number of the audio data that he/she wants to listen to.

In addition to the compact disc system, there has been system for playing digital audio of MPEG2 Layer 3 format that compresses digital audio data of WAV format, i.e., MP3 format. MP3 format can compress digital audio data of WAV format to one twelfth of the original data, but the quality of the original sound is nearly maintained. If the digital audio of MP3 format is recorded in a compact disc, analog audio data of about 850 minutes can be recorded. That is, 200 pieces of music can be recorded assuming that each of music is played during about 4 minutes.

When the digital audio data recorded by MP3 format is played, the conventional way for selecting music wherein the user selects audio data by referring to serial numbers given to about 300 pieces of music would consume considerable time. Further, the limitation to man's memorizing ability makes it difficult to select the wanted audio data by simply referring to serial number as the number of audio data increase.

For resolving this problem, there may be a method wherein the file name of digital audio data that is recorded by MP3 format is shown in a display and a user selects the wanted audio data by referring to the file name. However, in this method, the user should memorize the file name of the audio data that he/she wants to listen to. In addition, it is considered that selecting the wanted audio data from 300 pieces of music, each of which has different file name from one another, does not substantially differ from selecting the wanted audio data by referring to the serial number.

Alternatively, there may be a method of using ID3 Tag, i.e., information tag relating to audio data defined in MP3 format. ID3 Tag is additional information relating to audio data by MP3 format. ID3 Tag is inserted inside of the file by MP3 format. The portion of the file by MP3 format, where the ID3 Tag is inserted, is referred to “ID3 Tag Recording Area.” FIG. 1 is a conceptual drawing showing a typical format of MP3 file. As illustrated in FIG. 1, a typical MP3 file includes Audio Data Recording Area (101) and ID3 Tag Recording Area (103).

In the method of using ID3 Tag, recorded audio data is indicated by referring to ID3 Tag and the user selects the wanted audio data by referring to the indicated ID3 Tag Information. However, in this method, ID3 Tag Recording Area (103) of all of audio data which is recorded in a compact disc should be referred to and should be indicated. Thus, as the number of audio data increase, there would be problem that the required time for accessing ID3 Tag Recording Area of all audio data increases. Further, ID3 Tag Recording Area of all digital audio data of MP3 format must not include ID3 Tag Information. Thus, the method of using ID3 tag is useless for the digital audio data of MP3 format in which ID3 Tag is not recorded.

In order to overcome the problem, the inventor of the present invention filed a patent application relating to a method of indicating data in playing system for digital audio as Korean Patent Application No. 1999-001553 on Jan. 20, 1999. The method of indicating data in the digital audio playing system uses recording media in which audio data file of MP3 format is hierarchically recorded in directory structure. The display window of the playing system is comprised of a directory structure display for showing information relating to directory structure and selected item display for showing information relating selected directory structure or file. The directory structure display shows the title of the right above directory of the selected directory, the number of files and the sub directories which are included in said right above directory. The selected item display shows the order of the selected directory and file and playing time. The user can easily select wanted file from the recording media in which audio data is recorded in hierarchical directory structure.

Further, the inventor filed a patent application relating to a method of classifying and playing audio data which is recorded in digital audio recording media as Korean Patent Application No. 1999-6058 on Feb. 24, 1999. The invention of the application is for providing a method for effectively classifying and playing the audio data by databasing the additional information of audio data recorded in digital audio recording media and the recording position of the audio data in the recording media. The method of classifying and playing the audio data comprises a step of databasing the additional information of audio data and the recording position of the audio data in the recording media, thereafter storing the database and a step of searching the wanted data according to the field value of the database stored in previous step, thereafter playing the data.

According to Korean Patent Application No. 1999-6058, it is necessary to record the additional information in the recording media. In a first embodiment, files in which fields that are necessary for making the database of additional information are recorded, are recorded in the recording media itself. In this case, the file relating to the additional information is also recorded while audio data is recorded in the recording media. In playing, the additional information file is read to be used in classifying and playing the audio data.

In a second embodiment for recording the additional information in a recording media, the field that is necessary for making database of the additional information, is inserted to file name or directory name. In playing, the database of the additional information is made from the file name or the directory name so that the database is used in classifying and playing of the audio data.

### DISCLOSURE OF THE INVENTION

The present invention is improvement to said conventional arts. The object of the invention is to provide a method and an apparatus wherein additional information is inserted when digital audio data is recorded in a recording media, the additional information being used in searching and playing the digital audio data, thereby improving the speed of searching and playing.

Another object of the present invention is to provide a method and an apparatus wherein the format of the digital audio data file which is recorded in a recording media is converted to the format including index information to be used in searching the digital audio data file, thereby improving the speed of searching the digital audio data file.

The other object of the present invention is to provide a method for effectively playing audio data by databasing the additional information that is stored in the digital audio recording media and the recording position of the audio data in the recording media.

In order to accomplish the objects, the present invention provides the method for making database for use in searching digital audio data files from a first recording media, said first recording media having directory information recording area where information regarding directory is recorded and data recording area where file data is recorded according to information regarding sub file of the directory recorded in said directory information recording area, said digital audio data files including file name fields which are recorded in said directory information recording area, data fields and additional information tag field which are recorded in said data recording area. The method comprises (a) step for making directory database which is constituted by fields including name of said directory and recording position of said directory in said directory information recording area, for all directories recorded in said directory information recording area; (b) step for making file database which is constituted by fields including name of sub file and position in which said sub file is recorded in said data recording area by accessing said recording position in said directory information recording area, for all directories recorded in said directory database; (c) step for recording index information as field of said file database, said index information being used as keyword when said digital audio data file is searched.

According to another aspect of the present invention, a method for searching predetermined digital audio data file from a first recording media is provided. The first recording media having directory information recording area where information regarding directory is recorded and data recording area where file data is recorded according to information regarding sub file of the directory recorded in said directory information recording area. The digital audio data files including file name fields which are recorded in said directory information recording area, data fields and additional information tag field which are recorded in said data recording area. The method comprises (a) step for making directory database which is constituted by fields including name of said directory and recording position of said directory in said directory information recording area, for all directories recorded in said directory information recording area, and recording said directory database in said second recording media; (b) step for making file database which is constituted by fields including name of sub file and position in which said sub file is recorded in said data recording area by accessing said recording position in said directory information recording area, for all directories recorded in said directory database, and recording said file database in said second recording media; (c) step for inserting index information as field of said file database to said file database, said index information being used as keyword when said digital audio data file is searched, and recording said it in said second recording media; (d) step for receiving input of name of digital audio data file to be searched; (e) step for searching file having same name as said inputted digital audio data to be searched from file name fields of said file database, and reading recording position field corresponding to searched file name field.

According to another aspect of the present invention, a method for searching predetermined digital audio data file from a first recording media is provided. The first recording media having directory information recording area where information regarding directory is recorded and data recording area where file data is recorded according to information regarding sub file of the directory recorded in said directory information recording area. The digital audio data files including file name fields which are recorded in said directory information recording area, data fields and additional information tag field which are recorded in said data recording area. The method comprises (a) step for making directory database which is constituted by fields including name of said directory and recording position of said directory in said directory information recording area, for all directories recorded in said directory information recording area, and recording said directory database in said second recording media; (b) step for making file database which is constituted by fields including name of sub file and position in which said sub file is recorded in said data recording area by accessing said recording position in said directory information recording area, for all directories recorded in said directory database, and recording said file database in said second recording media; (c) step for inserting index information as field of said file database to said file database, said index information being used as keyword when said digital audio data file is searched, and recording said it in said second recording media; (d) step for receiving input of name of digital audio data file to be searched; (e) step for searching file having index information conforming to said inputted index information to be searched by accessing said file database.

### BRIEF DESCRIPTION OF THE DRAWINGS

FIG. 1 conceptually shows a typical MP3 file format.

FIG. 2 shows the block diagram of the structure of an apparatus according to the present invention, for reading and playing digital audio data from recording media in which the digital audio data is recorded.

FIG. 3 is a schematic drawing which illustrates the structure of digital audio data file.

FIG. 4 is a schematic drawing which illustrates the state wherein the digital audio data file is recorded in recording media.

FIG. 5 conceptually shows the structure of database which is stored in root directory of compact disc of ISO-9660 format in the playing apparatus of digital audio recording media illustrated in FIG. 2.

FIG. 6 is a schematic drawing which illustrates directory structure wherein field value is inserted to the file name in order to constitute database, according to the another embodiment of the present invention.

FIG. 7 is a flow chart which shows background processing for constituting in memory of playing system.

FIG. 8 is a schematic drawing which illustrates the structure of directory database which is built according to the present invention.

FIG. 9 conceptually shows the structure of file database which is made according to the present invention.

FIG. 10 conceptually shows the structure of genre database which is made according to the present invention.

FIG. 11 conceptually shows the state wherein the database built according to the present invention is recorded in the recording media.

FIG. 12 shows an example of input window adopted by a program that converts the inputted digital audio data file to digital audio data file format in accordance with the present invention, in a preferred embodiment of the present invention.

### BEST MODE FOR CARRYING OUT THE INVENTION

1. Digital Audio Data, Recording Media and Playing Apparatus

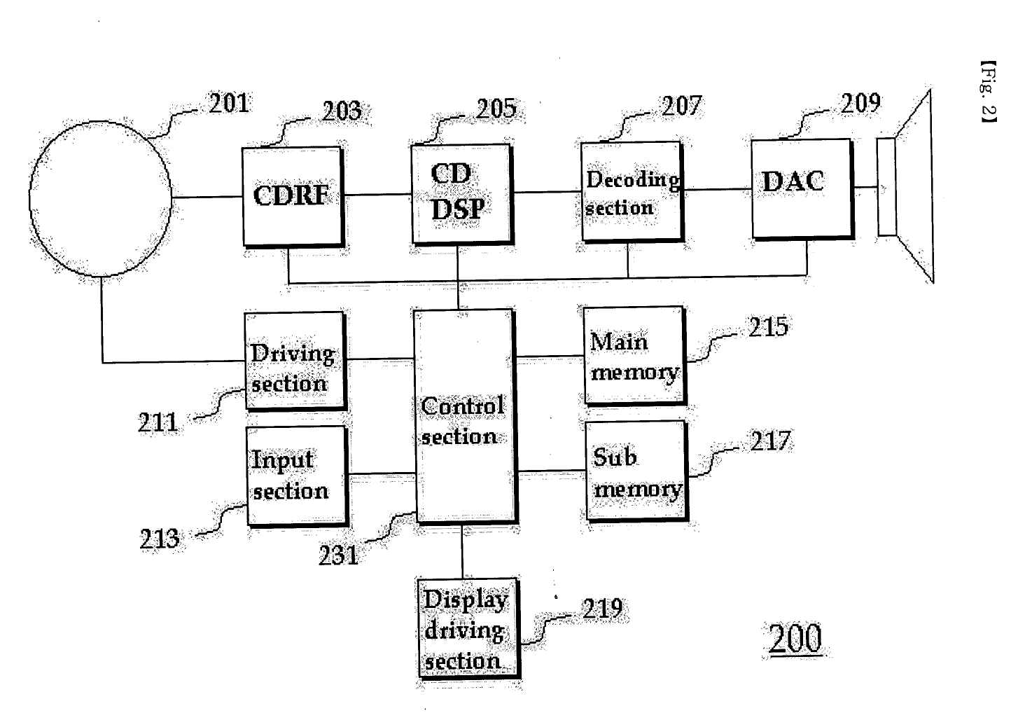

FIG. 2 is a block diagram illustrating the structure of an apparatus for reading and playing digital audio data from recording media in which the digital audio data is recorded, according to the present invention.

Playing apparatus (200) illustrated in FIG. 2 reads and plays the digital audio data while driving the recording media (201). Playing apparatus (200) for digital audio data according to the present invention, comprises reading portion (203) for reading recorded information from recording media (201); digital processing portion (205) for extracting digital information signal from the read recorded information and appropriately processing the signal; decoding portion (207) for generating digital audio signal by decoding digital information signal; digital-analog converting portion (209) for supplying analog signal which is converted from digital audio signal to output apparatus of audio signal; driving portion (211) for moving recording media (201) or reading means, synchronizing with the reading operation of recording media, in order to change the reading position on recording media (201); input portion (213) for receiving input of a command from the user; display portion (219) for showing information of recording media (201), digital audio data or additional information; main memory (215) and sub-memory (217) for recording information which is temporarily generated relating to recording media (201), digital audio data or additional information; and control portion (231) for controlling the portions. It is preferred that main memory (215) is volatile memory so that the stored contents are removed when the playing apparatus is not working. However, it is preferred that sub-memory (217) is non-volatile memory so that the stored contents are maintained while the playing apparatus is not playing or searching. The database (which will be described in the below) for audio data file which is recorded in the recording media, is recorded in sub-memory (217) when the recording media is inserted for the first time. Thereafter, if the recording media is inserted, only sub-memory (217) is referred to, without making database. Memory such as DRAM may be used as main memory (215). Memory such as flash memory may be used as sub-memory (217).

Recording media (201) includes all of the optical or magnetic recording media (201) in which digital data can be recorded, such as CD, MD, DVD, MO. If digital data can be recorded, recording media such as hard disk or diskette is included in recording media (201) that is referred to in the present invention.

In the specification, the unit where audio signal to be consecutively played is recorded, is referred to as an audio data file. That is, when a file is played, the digital audio data recorded in the file is consecutively played unless another instruction occurs. Generally, when music is digitalized, a piece of music is recorded in a file. The digital audio data file may have PCM format wherein audio signal is digitalized without data compression, or MP3 format wherein the audio signal is digitalized with data compression.

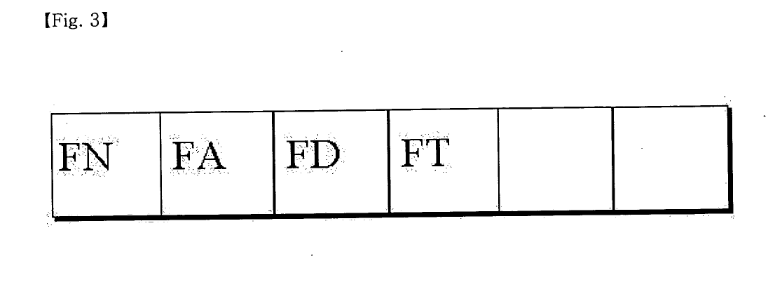

FIG. 3 is a schematic drawing which shows the structure of one digital audio data file. Each of the digital audio data file may be comprised of Field of File Name (FN), Field of File Attribute (FA), Field of Data (FD), Field of Additional Information Tag (FT).

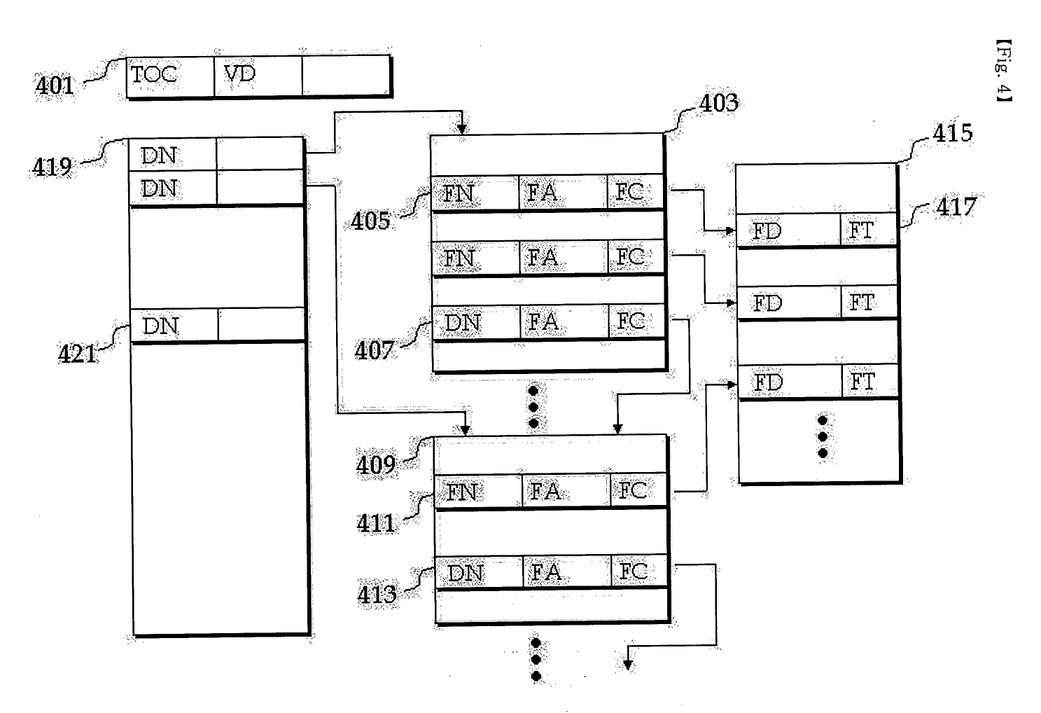

The digital audio data file having the structure of FIG. 3 can be recorded in various recording media. The file is recorded in accordance with the rule of file system that is determined by the characteristic of the recording media. FIG. 4 is a schematic drawing that shows the state wherein a number of digital audio data files are recorded in the recording media according to a predetermined rule of the file system. In FIG. 4, the recording media is a one time recordable-multi readable optical recording media, for example, CD-ROM.

In FIG. 4, recording area (401) for disc information including table of contents (TOC), recording area for root-directory information (403), recording area for sub directory information (409), and recording area for data (415) are assigned in the recording media.

The unique information of the recording media, such as the name of the recording media, total recording capacity and time at which recording is done, are recorded in recording area (401) for disc information. Recording area (401) for disc information may include TOC and Volume Describer (VD). In particular, Volume Describer (VD) has information for indicating the position of directory path information recording area (419) to be described hereinafter.

File information (405) of the highest parent directory, i.e., root directory and information (407) of sub directory are recorded in recording area (403) for root directory information are included in root directory information recording area (403). The recording area (409) for the sub directory information includes file information (411) included in the directory and sub directory information (407) of said directory for the sub directory of the root directory and the sub directory of said sub directory. Further, the file information included in directory information recording area (403, 409) and the data and tags related to the file information are recorded in data recording area (415). The recording media may further include directory path information recording area (419). Path information of all directories that are recorded in the recording media is recorded in directory path information recording area (419). Directory path information recording area (419) can be read by referring to Volume Describer as described in the above.

In directory information recording areas (403, 409), file information (405) that is recorded in the directory and information (407) of sub directory are recorded. File information (405) includes Field of File Name (FN), Field of File Attribute (FA), Field of Data Recording Address (FC). Sub directory information (407) includes Field for Directory Name (DN) and Field for Directory Attribute (DA). File information (405) and sub directory information (407) may have extra field (FE) depending on an employed file system. Data (FD) and Tag Information (FT) that relates to File Information (405) are recorded in the address on data recording area (415), which is indicated by data recording address field (FC) of the file information.

In the above, the present invention is described by referring to the one time recordable-multireadable optical recording media illustrated in FIG. 3. However, multirecordable-multireadable recording media, such as hard disc and floppy disc may employ file system using File Allocation Table (FAT). That is, it is also possible that Data Recording Address Field (FC) does not indicate the address in the direct data recording area, but indicates the address in File Allocation Table (FAT) and that File Allocation Table (FAT) indicates the position in the recording area.

That is, File Name (FN), File Attribute (FA), Data (FD) and Additional Information Tag (FT) constituting the digital audio data file as illustrated in FIG. 3, are recorded in directory information recording area (403, 409) and data recording area (415), as shown in FIG. 4, in accordance with an appropriate file system rule.

In the below, the process of accessing a predetermined digital audio data file will be explained for the case that the digital audio data file is recorded according to the file system shown in FIG. 4. Generally, such a file system is managed by a computer and an operating system that is operated in a computer. Further, the file system can be managed by the playing apparatus for digital audio, which is shown in FIG. 2. Alternatively, an applicative program which is operable in a computer, the operating system, or the playing apparatus for digital audio data, may process the file access to digital audio data. In this specification, the computer, the operating system, the playing apparatus for digital audio data or applicative program that manages the file system which is illustrated in FIG. 4, is referred to as managing system.

First, the access process wherein key word is an inputted file name, will be explained. When a file name is inputted, the managing system compares the inputted file name with File Name Field (FN) in file information (405,411) in directory information recording areas (403,409), while searching all sub directory information recording area (409) one by one, starting from root directory information recording area (403). As a result of comparison, if File Name Field (FN) where the same file name as the inputted file name is recorded is found, the wanted Digital Audio Data (FD) on data recording area (415) can be accessed by referring to Data Address Recording Field (FC) corresponding to said File Name Field (FN).

Second, the access process wherein key word is an inputted additional information will be explained. This process is used for a case that the user does not remember the file name of the audio data, but remembers the additional information relating to the audio data, for example, composer or player, or genre. When the additional information is inputted, the managing system extracts Data Address Recording Field (FC) from each file information by referring to all of the file information that is recorded in directory information recording area (403, 409), while searching all of sub directory information recording area (409) one by one, starting from root directory information recording area (403). Then, Additional Information Tag Field (FT) on data recording area (415) which is indicated by Data Address Recording Field (FC), is searched. If Tag Field (FT) in which the same additional information as the inputted additional information is recorded, is found, the wanted Digital Audio Data (FD) can be accessed in data recording area (415) by referring to Data Address Recording Field (FC).

As clearly understood from the above, the access process for digital audio data by referring to file name differs from the access process for digital audio data by referring to additional information. That is, when referring to the file name, it is necessary only to search directory information recording area (403). However, when referring to the additional information, it is necessary to search not only directory information recording area (403) but also data recording area (415). Further, all of additional information tag field (417) should be read out. Thus, it can be seen that the file access time by referring to the additional information is longer than the file access time by referring to the file name.

2. File Format of Digital Audio Data

Digital audio data file is comprised of File Name (FN), File Attribute (FA), Data (FD), and Additional Information Tag (FT). According to the present invention, File Name (FN) and File Attribute (FA) are recorded in directory information recording area (403, 409); Data (FD) and Additional Information Tag (FT) is recorded in data recording area (415); and the additional information which would be used as keywords when the digital audio data is searched is recorded in directory information recording area (403, 409). In this specification, the file format of digital audio data wherein the additional information which would be used as a keyword when the digital audio data recorded in a recording media is searched, is recorded in directory information recording area (403, 409), is defined as “FIF format.” Further, the additional information which would be used as keyword in FIF format, is defined “index information.”

According to a preferred embodiment, particularly, the index information which would be used as keywords when the digital audio data is searched, is recorded in File Name Field (FN) among directory information recording area (403, 409). In this case, the index information of the digital audio data can be expressed by a file name in the operating systems such as DOS and Windows.

According to another embodiment, particularly, the index information which would be used as keywords when the digital audio data is searched, is recorded in a predetermined field except for File Name Field (FN) among directory information recording area (403,409). That is, the index information which would be used as keywords is recorded in File Attribute Field (FA) or Extra Field (FE). In this case, the index information of the digital audio data is recorded in the form of hidden information that cannot be recognized by the file name, in the operating systems such as DOS or Windows. It seems that the recorded digital audio data file has a conventional file name through a traditional computer, operating system, or playing apparatus for digital audio. However, the use of applicative program according to the present invention makes it possible to indicate the additional information with the file name in addition to the conventional file name.

According to the present invention, when a user wishes to search a digital audio data by use of additional information as keyword, playing apparatus (200) only has to read directory information recording area (403, 409) of recording media. There is no need to access data recording area (415). Thus, the time for searching digital audio data can be considerably reduced. Further, according to the present invention, as will be described in the below, the information of digital audio data recorded in the recording media can be databased to be recorded in sub-memory (217). Even in this case, playing apparatus (200) only has to access directory information recording area (403, 409) in order to make a database. Thus, the time for making the database can be considerably reduced. The details of the above will be explained in the below.

According to a preferred embodiment, as keywords for searching digital audio data, the additional information such as title, composer or player and genre of the music formatted to the digital audio data file, may be used. In this case, it is desirable that the additional information is distinguished from one another by a predetermined distinguisher. For example, in the embodiment employing FIF format wherein additional information is recorded in File Name Field (FN), the additional information is distinguished by use of the mark “[” and “].” In this case, operating systems such as DOS and Windows can express the file name of the digital audio data file in FIF format as the form of “[player] [title of the music] [genre].extension.” However, the kinds of the index information for searching digital audio data and the arranging order thereof are not limited to the above embodiments. They can have various forms and applications. It should be noted that the spirit of the present invention is not limited to the above embodiments. For example, the file name of a digital audio data file has the form of “[title of music] [singer] [genre].extension” or “[title of music] [singer] [genre] [miscellaneous additional information].extension.”

3. Inserting Method, Apparatus and Program of Index Information

According to the preferred embodiments of the present invention, a method, apparatus and program for converting a digital audio data file into FIF format, are provided. Digital audio data file is comprised of File Name (FN), File Attribute (FA), Data (FD), and Additional Information Tag (FT). According to the present invention, File Name (FN) and File Attribute (FA) are recorded in directory information recording area (403, 409); Data (FD) and Additional Information Tag (FT) is recorded in data recording area (415); and the additional information which would be used as keyword when the digital audio data is searched is recorded in directory information recording area (403, 409).

According to the preferred embodiment of the present invention, particularly, the additional information which would be used as keywords when the digital audio data is searched, is recorded in File Name Field (FN) among directory information recording area (403, 409). According to another embodiment of the present invention, particularly, the index information which would be used as keywords when the digital audio data is searched, is recorded in a predetermined field except for File Name Field (FN) among directory information recording area (403, 409). That is, the index information which would be used as keywords is recorded in Attribute Field (FA) or Extra Field (FE).

The additional information which would be used as keywords when the digital audio data is searched, can be obtained by direct input of the user or by extracting the additional information from Additional Information Tag (FT).

When the additional information can be obtained by direct input of the user, in the embodiment wherein the additional information regarding the title, composer or player, and genre of the music formatted to the audio data file is used as keywords for searching digital audio data, the title, the composer or player, and genre of the music are directly inputted by the user. Further, when the additional information can be obtained by extracting the additional information from Additional Information Tag (FT), the additional information is obtained by reading the field of the title, composer or player, and genre of the music, of the digital audio data file.

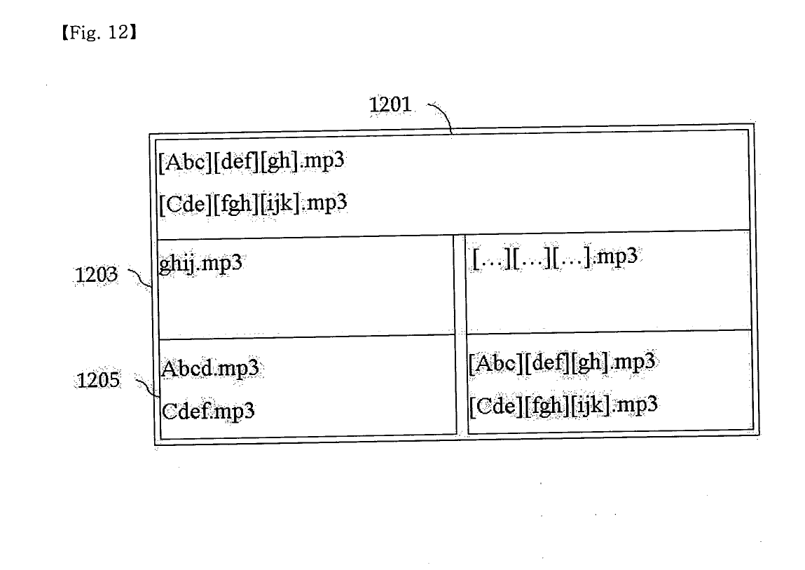

FIG. 12 shows an example of input window for computer display that is employed by the program which converts the inputted digital audio data file to the file format of digital audio data in accordance with the present invention. The input window shown in FIG. 12 includes display window (1201) for conversion-completed file, display window (1203) for to-be-converted file in which additional information input is required, display window (1205) for to-be-converted file in which additional information is obtainable.

According to the preferred embodiment of the present invention, display window (1203) for to-be-converted file in which additional information input is required, shows the list of files wherein the additional information of a file that a user wishes to convert is obtained by the user's input. Even when the user does not input, display window (1205) for to be-converted file in which additional information is obtainable shows the list of files which is extractible from Additional Information Tag (FT) that is attached to the digital audio data file.

If the user inputs additional information regarding to the files shown in display window (1203) for to-be-converted file in which additional information input is required, the file format is converted accordingly. The format of the converted file for example, the file name is shown in right window. For the files shown in display window (1205) for to-be-converted file in which additional information is obtainable, the format of the files to be expected to be converted, for example, the file name is shown in the right window.

Then, if the user inputs the command of requesting conversion, the program converts the files shown in file display windows (1203, 1205) to the file format shown in the right window, thereafter listing these in display window (1201) for conversion-completed file.

The display window shown in FIG. 12 and the process for managing the window can be included as a part of routine of the apparatus for inserting index information and a part of program. The display window shown in FIG. 12 and the processes related thereto can be also applied to a format converting apparatus and a program for digital audio data which will be described in the below, an apparatus and a program for recording the digital audio data in a recording media and a apparatus and a program for converting the conventional CD audio data to the format of the present invention, in the same way as described in the above. The detailed explanation related thereto is omitted.

4. Digital Audio Data Format Converting Method, Apparatus and Program

According to the present invention, a method, an apparatus and a program for converting the conventional digital audio data format to the digital audio data format to which index information is inserted according to the present invention.

If File Name (FN), File Attribute (FA), Data (FD) and Additional Information Tag (FT) are recorded in recording media and if File Name (FN) and File Attribute (FA) are recorded in directory information recording area (403,409), and Recording Data (FD) and Additional Information Tag (FT) are recorded in data recording area (415), the method converts the digital audio data format to the format of the present invention by recording the additional information which would be used as keywords when the digital audio data will be searched in directory information recording area (403, 409).

According to a preferred embodiment of the present invention, the format conversion is performed by recording the additional information which would be used as keywords when digital audio data is searched in directory information recording area (403, 409), in particular, the area in which File Name Field (FN) is recorded. According to the other embodiment of the present invention, the format conversion is performed by recording the additional information which would be used as keywords when digital audio data is searched, in directory information recording area (403, 409), in particular, an area except for the area in which File Name Field (FN) is recorded. That is, the additional information which would be used as keywords is recorded in Attribute Field (FA) or Extra Field (FE).

The method of obtaining the additional information which would be used as keywords when the digital audio data is searched is almost same as the method described in the above. Thus, the details of the method is not mentioned.

5. Method, Apparatus and Program by Which Digital Audio Data Is Recorded in Recording Media

The present invention provides a method, an apparatus and a 5 program by which digital audio data file is recorded in recording media as a format of the present invention.

The method records File Name (FN), File Attribute (FA), Data (FD), and Additional Information Tag (FT) which constitute digital audio data file, in recording media. File Name (FN), File Attribute (FA) are recorded in directory information recording area (403, 409). Data (FD) and Additional Information Tag (FT) are recorded in data recording area (415). The additional information which would be used as keywords when the digital audio data is searched, is recorded in directory information recording area (403, 409).

According to an embodiment of the present invention, a method which records, in the second recording media, the inputted digital audio data file recorded in the first recording media as FIF format of the present invention. In the first recording media, File Name (FN) and File Attribute (FA) which constitute digital audio data file, are recorded in directory information recording area (403,409). Data (FD) and Additional Information Tag (FT) are recorded in data recording area (415). When these are recorded in the second recording media, File Name (FN) and File Attribute (FA) are recorded in directory information recording area (403, 409). Further, Data (FD) and Additional Information Tag (FT) are recorded in data recording area (415). In addition, the additional information which would be used as keywords when the digital audio data is searched, are recorded in directory information recording area (403, 409). This embodiment is particularly useful when the first recording media and the second recording media have different file system from each other. That is, if the first recording media is a floppy disc and the second recording media is a hard disc, the format of the digital audio data file is converted to FIF format of the present invention when the file recorded in the floppy disc is copied to the hard disc.

6. The Program that Converts the Conventional CD Data to Compressive Digital Audio Data Automatically

According to the present invention, a method, a apparatus and a program that convert digital audio data which is recorded in CD as CD audio format into FIF format of the present invention.

The present method reads the digital audio data file which is recorded in a CD as CD audio format; extracts the digital audio data; generates object data (FD) by encoding the data by a demanded format; generates File Name, File Attribute (FA) and Additional Information Tag (FT); and records File Name (FN), File Attribute (FA), Data (FD) and Additional Information Tag (FT) on recording media. File Name (FN) and File Attribute (FA) are recorded in data recording area (403,409); Data (FD) and Additional Information Tag (FT) are recorded in data recording area (415); and the additional information which would be used when the digital audio data is searched is generated to be recorded in directory information recording area (403, 409).

According to an embodiment of the present invention, it is preferred that the digital audio data which is recorded in a CD by CD audio format is compressed by a compression algorithm before being recorded in recording media. For example, the digital audio data recorded in a CD by CD audio format can be compressed to a file which is modulated by PCM format, a file of WAV format or MP3 compression algorithm, thereafter being recorded in the recording media. In this case, compression algorithm may be for example, MP3 compression algorithm.

The additional information which would be used as keywords when the digital audio data is searched, may be obtained by a user's direct input or extracting the information after accessing to CD information database.

In the former case, if title of the music, composer or player, and genre of the music are used as the keywords for search of digital audio data, the additional information of the title of the music, composer or player, and genre of the music are directly inputted by the user. In the latter case, title of music, composer or player, and genre of music of digital audio data file is obtained with the unique information of the audio CD as keywords by accessing CD information database.

The CD information database means the database in which various additional information regarding the audio CD is recorded by means of unique information of the audio CD. Generally, such a database can be accessed through a communication network such as internet. Further, in the CD information database, information such as title of music, composer and player, and genre of music regarding a number of music is recorded. If the user who wishes to obtain detailed information regarding an audio CD accesses the CD information database through a communication network and sends the unique information of the audio CD to the CD information database, the CD information database searches the audio data conforming to the sent unique information and sends the additional information regarding the audio data to the user.

In the file system shown in FIG. 4, the unique information such as the title, total recording capacity, time at which the audio CD is made may be used as unique information for distinguishing a number of audio CDs from one another in the CD information database.

7. Method and Apparatus for Making Database from Recording Media Where Digital Audio Data is Recorded.

The apparatus for searching and playing digital audio data in accordance with the present invention, uses directory database, file database and index information database which are made from the recording media where digital audio data is recorded. According to an embodiment of the present invention, the index information database includes musician database and genre database.

(1) Database Structure

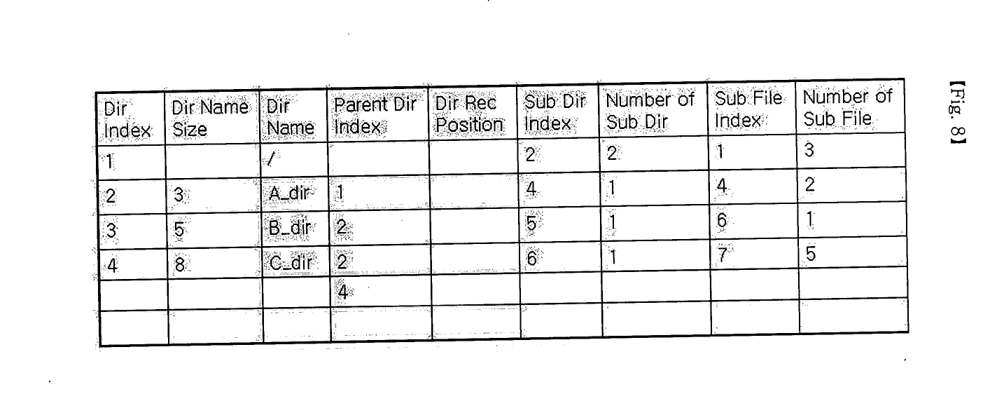

In the below, the structures of the directory database, the file database and the index information database which are employed in the apparatus for searching and playing digital audio data in accordance with the present invention, will be explained by referring to FIGS. 8-10.

The directory database records the directory structure of the recording media where the digital audio data is recorded in accordance with the present invention. As illustrated in FIG. 8, the directory database includes Directory Index (Dir Index), Directory Name Size (Dir Name Size), Directory Name (Dir Name), Parent Directory Index (Parent Dir Index), Position of Directory Information Recording Area (Dir Rec Position), Sub Directory Index (Sub Dir Index), Number of Sub Directory (Number of Sub Dir), Sub File Index (Sub File Index) and Number of Sub File (Number of Sub File).

Directory Index (Dir Index) is a serial number for referring to directory registered in the database. Directory Name Size (Dir Name Size) is a field where the size of the directory name is recorded. Directory Name (Dir Name) that is a field in which the directory name is recorded, is assigned according to the size recorded in the field of directory name. The size of the field of directory name is variable and can be checked by referring to the field of directory name size. For example, as shown in FIG. 8, the directory which has index “3” has directory name size of “5.” Thus, the field of directory name having size “5” is assigned. Further, the directory name field has directory name “B_dir” which has size of “5.”

Parent Directory Index (Parent Dir Index) field memorizes the index of the parent directory of the directory, on the directory database. For example, it is noted that the parent directory of the directory having index “3” is the directory having index “2.”

The field of Position of Directory Information Recording Area (Dir Rec Position) memorizes the position where the information regarding the directory is recorded. Referring to the field of Position of Directory Information Recording Area (Dir Rec Position), the position of the recording media where the information regarding the wanted directory is recorded, can be searched.

The field of Sub Directory Index (Sub Dir Index) and the field of Number of Sub Directory (Number of Sub Dir) memorize the first index where the sub directory of the directory is recorded in the directory database. By referring to Sub Directory Index, the position on the directory database, where the information regarding the sub directory of the directory is recorded, can be searched. Further, by referring to the field of Number of Sub Directory as well as the field of Sub Directory Index, it is possible to extract only the area on the directory database where the information of the sub directory of the directory is recorded.

The sub file index field (Sub File Index) and the field of number of sub file (Number of Sub File) memorize the first index where the sub directory of the directory is recorded on the file database, and the number of the sub files. By referring to Sub File Index, the position on the directory database, where the information regarding the sub directory of the directory is recorded, can be searched. Further, by referring to the field of Number of Sub File as well as the field of Sub File Index, it is possible to extract only the area on the file database where the information regarding the sub file of the directory is recorded.

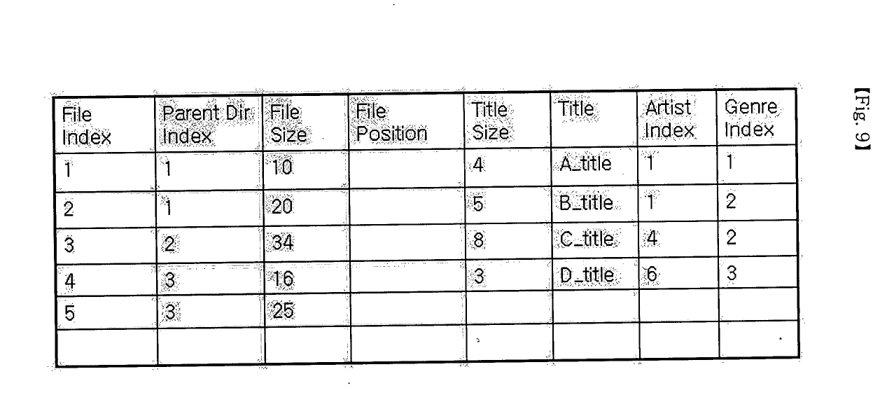

The file database records all information of audio data file that is recorded in the recording media where the digital audio data is recorded in accordance with the present invention. As illustrated in FIG. 9, the file database includes File Index, Parent Directory Index, File Size, File Position, Title Size, Title, Index of Index Information for example, Artist Index and Genre Index fields.

File Index is a serial number for referring to the file that is registered on the file database. Parent Directory Index Field memorizes the index on directory database of the parent directory of the file. For example, as shown in FIG. 8, the parent directory of the file having index “3” is the directory having index “2” on the directory database.

File Size is the field in which the capacity the audio file occupies on CD is recorded. File Position Field is the field where the recording position of the audio data file on a recording media is recorded. By referring File Position Field, the position on the recording media, where the information regarding the wanted file is recorded, can be searched.

Title Size is the field where the size of title of a music of the audio data. Title that is the field where the title is recorded, is assigned according to the size recorded in Title Size Field. The size of Title Field is variable and can be checked by referring to Title Size Field. For example, as shown in FIG. 9, the title of the file having index 3” has the size of “8.” Thus, the title field of the size “8” is assigned. Further, Title Field has the title “C_title” having the size of “8” recorded thereon.

File database databases the index information which would be used when the file is searched, thereafter recording the information. In FIG. 8, the file database according to an embodiment of the present invention includes Artist Index Field and Genre Index Field as index information fields. Artist Index Field and Genre Index Field records the indexes of musician and genre on index information database which will be described in the below, regarding the musician and genre of the audio data file.

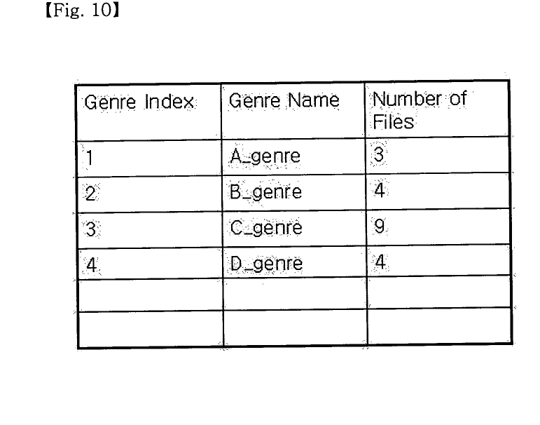

FIG. 10 shows the structure of index information database in accordance with an embodiment of the present invention. FIG. 10 shows the structure of genre database among the index information database. In the below, genre will be explained as one of the index information.

As shown in FIG. 10, Genre Database includes fields of Genre Index, Genre Name, Number of Files. Genre Index is a serial number for referring to genre registered on Genre Database. The field of Genre Name memorizes the name of genre. The field of Number of Files memorizes, the total number of files in which the genre is recorded as index information for searching.

(2) Initial Operation When Recording Media is Inserted for the First Time and Process for Making Database

In the below, the operation when the recording media which is recorded by the format of digital audio data file in accordance with the present invention is inserted to a playing apparatus for the first time, will be described. The description is for the system wherein the digital audio data file having said format of the present invention is recorded in a recording media as the file system shown in FIG. 4.

When the recording media in which the digital audio data is recorded by the file system shown in FIG. 4 is inserted, the playing apparatus accesses disc information recording area (401). The playing apparatus reads unique information of the recording media, such as the name of the recording media, total recording capacity, the time at which the recording is performed.

Then, it is judged whether the read information partially or totally conforms to the information that has been already recorded in sub-memory (217). If they do not conform to each other, it is considered that the inserted recording media is inserted for the first time, thereafter performing following process. The technique wherein the unique information of the recording media is recorded in sub memory (217), win be described in the below.

If it is regarded that the recording media is inserted for the first time, the unique information of the recording media, which is read from disc information recording area (401), is recorded in sub memory (217).

Then, the directory database as shown in FIG. 8 is made, and is recorded in sub memory (217). It is desirable that the directory database is recorded at a position which is associated with the recording position where the unique information of the recording media is recorded.

The process of making the directory database will be described. First, directory path information recording area (419) is accessed by referring to disc information recording area (401), particularly volume describer (VD). From the directory path information recording area, the recording position in which the directory information recording area is recorded, is read, for all of the directories recorded in the recording media. Next, the fields of the directory database is made by reading directory information recording area (403, 409) for all of the directories which are recorded in directory path information recording area (419).

The size of directory name is calculated and is recorded in the field of directory name size. Directory name field is assigned based on the field. Directory name is recorded in directory name field that is assigned based on the field of the directory name size. The fields on the other directory database is filled by referring to directory path information recording area (419) or directory information recording area (403, 409).

The file database shown in FIG. 9 is made and is recorded in sub memory (217) after or simultaneously with making the directory database. At this time, it is desirable that the file database is recorded in a position, associated with the position where the unique information of the recording media or the directory database is recorded.

In the below, the process for making the file database will be described. If the directory recorded in the directory database has a sub file, the sub file is registered in the file database and the index on the file database is recorded in the field of Sub File Index (Sub File Index) on the directory database. For each of the directories recorded in the directory database, each field of the file database is filled by referring to directory information area (403, 409).

According to the present invention, it is unnecessary to access the file recording area (415) where the files are actually recorded for making the file database. In particular, since the index information for reading digital audio data from a recording media is recorded in the directory information recording area, it is possible to fill the index information recording field of the file database by accessing the directory information recording area.

Together with making the file database, the index information database as shown in FIG. 10 is made and is recorded in sub memory (217).

In the below, with referenced to FIG. 10, the process for making genre database among index information is described. While making the file database, the information regarding the genre of the file is read from directory information recording area (403, 409). Then, it is judged whether there is the genre recorded in the genre database which conforms to the read genre. If there is the recorded genre which conforms to the read genre, the genre index is recorded in the genre index field of the file database. Further, the number of the files that is recorded in the file number field of the genre database, increases by one (1). If there is no recorded genre which conforms to the read genre, new genre item is generated in the genre database. In addition, the index of the newly generated genre item is recorded in the genre index field of the file database. The file number field of the newly generated genre item is set by 1.

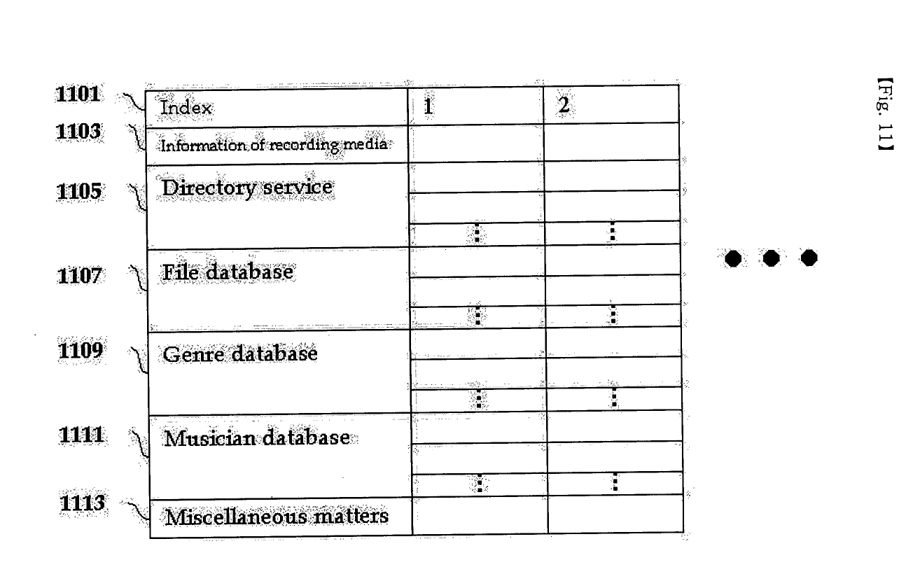

As described in the above, when a number of databases are made from the recording media in which digital audio data is recorded, the databases are recorded in sub memory (217). FIG. 11 is conceptually shows a number of databases that are recorded in sub memory (217). According to FIG. 10, in sub memory (217), is recorded unique information (1103) of a recording media, which is read from disc information recording area; directory database (1105) that is made from directory path information recording area (419) and directory information recording area (403,409); file database (1107) that is made from directory information recording area (403,409); and genre database (1109) and musician database (1111) that is made together with making the file database. According to an embodiment of the present invention, index (1101) regarding each recording media may be recorded. Further, according to a preferred embodiment of the present invention, information (1113) such as database making time and renewal time for each recording media can be recorded.

(3) Initial Operation When Recording Media is Secondly Inserted to Playing Apparatus and Process for Making Database

The operation for the case that after the databases shown in FIGS. 8 to 10 are made and are recorded in sub memory (217) as shown in FIG. 11, the same recording media is inserted again, will be described in the below.

When the recording media in which digital audio data is recorded by the file system shown in FIG. 4, a playing apparatus accesses disc information recording area (401). The playing apparatus reads the unique information of the recording media such as the name of the recording media, total recording capacity, the time at which recording is performed, which are recorded in disc information recording area (401).

Next, it is judged whether the read information partially or totally conforms to the information that is already recorded in sub memory (217). In particular, it is judged whether the read information conforms to the unique information (1103) of the recording media for all of the recording media recorded in sub memory (217). If the same information is already recorded, it is regarded that the database of the inserted recording media is completely made when it was inserted for the first time. The operation of making database as described in the above can be omitted.

The process for searching and playing digital audio data from the recording media will be described in the below.

(4) Method and Apparatus for Searching and Playing Digital Audio Data Which are Recorded in Recording Media

The method for searching and playing audio data from a recording media by using the databases of the recording media, which are made and are completely recorded in sub memory (217), will be explained. The operation after the databases are made for the case that the recording media is inserted to the playing apparatus for the first time, is same as the operation after it is considered that the databases are made for the recording media after the recording media was inserted.

The case that a user searches an audio data by title of music as a keyword, will be described. Playing apparatus (200) accesses file database recording area (1107) of sub memory (217), thereafter showing file list which is recorded in file database (1107) in display driving portion (219). If the user selects the wanted file from the file list shown in the display device, playing apparatus (200) reads File Position from the file database of sub memory (217) and accesses the position of the selected file on the recording media. Next, with reference to the filed of File Size, data having the capacity of the file is read and is played.

The case that a user searches an audio data by index information for example, genre as keyword, will be explained. Playing apparatus (200) accesses the recording area of genre database (1109) of sub memory (217), thereafter showing genre list which is recorded in genre database (1109) in display driving portion (219). If the user selects a genre from the genre list shown in the display apparatus, playing apparatus (200) searches the files that have the index conforming to the index of the genre database while reading the field of genre index from file database of sub memory (217). If the file included in the genre that the user selects is found, the title of the file is searched from title field and is shown in display. According to the present invention, in order to minimize the searching time, if with reference to the field of Number of Files, the files having the genre, of the number recorded in the filed of Number of Files, are found, searching database is terminated. Then, the titles of the found files are displayed.

If the user wishes to play the files included in the selected genre, file databases of all of the files included in the list is accessed. With reference to the field of File Position, the position of the files on the recording media is accessed. Then, the data having the capacity of the file size is read and is played by referring to the field of file size. The process is repeated for all of the files included in the list.

If the user wishes to play the selected files among the files included in the selected genre, search and play processes by the file names are performed. The details on this operation is omitted.

8. Method for Classifying and Playing Audio Data Recorded in Digital Audio Recording Media

In the below, audio data means digitalized audio signal and additional information means information for classification and play of audio data, such as singer, genre, year of making, album, title of music, classification mark. Further, position information means the position information for accessing the audio data on the recording media. In addition, database means the database having additional information and position information for playing audio data by classification as field.

The first embodiment of the present invention is a mode wherein database is made in recording media itself. For example, when music is recorded in a CD, the database is also recorded in the CD as files so that playing system reads the files to recognize all information necessary for playing the CD by classification, thereby facing the user's request of playing by classification.

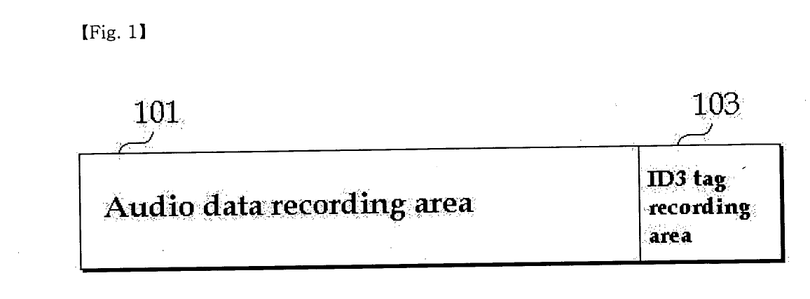

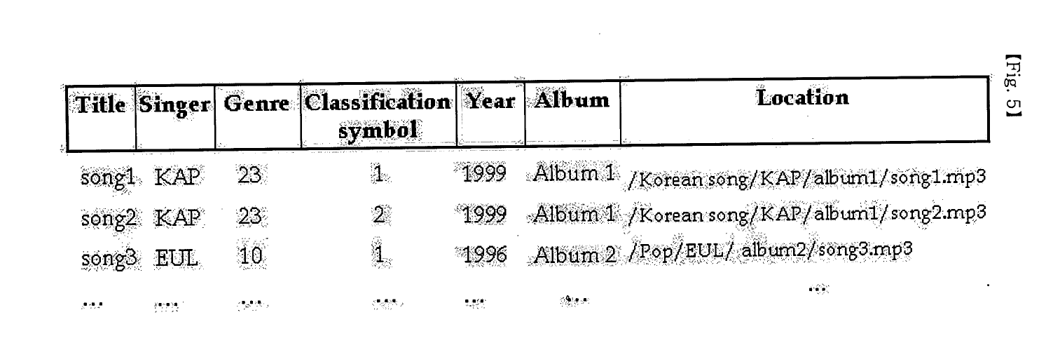

FIG. 5 shows an example of the contents of a database that is recorded in ISO-9660 format CD in a playing system of digital audio recording media illustrated in FIG. 1.

As shown in FIG. 5, the database recorded in CD can store title of music, singer, genre, classification number, year of making, album and the position information of the music on CD.

If such a database is disposed in the root directory of CD, the access is rapid. Further, only first one reading make it possible to have databased information for playing by classification. Thus, this system can show immediate response to the user's request since the database is classified without access time to ID 3 Tag of files for playing by classification and since the music can be immediately found by use of position information stored in the database.

For example, if a user wishes to play audio data by classification of singer, the playing system shows the signer list from the database. If the user wishes to play music of singer “A,” the playing system shows the list of music of singer “A” from the database. The database shown in FIG. 5 shows music 1 and music 2. If the user selects music 1, it is possible that the position of music 1 is accessed by using the position information of music 1 from the database. Thus, it is possible that the required time for finding music by analyzing path table, directory information and each audio data, is reduced.

In another embodiment of method of classifying and playing audio data stored in a digital audio recording media, according to the present invention, database is made only by file name or directory name by putting necessary field for making database to the file name or directory name. In the playing system, database is made in memory by use of record information and file position information which are included in file name or directory name by use of position information of each file included in directory recording. Necessary additional information for playing by classification is inserted to the file name or directory name when manufacturing CD. Using this file name or directory name, database is made in memory of playing system. The audio data is classified and played by the database. This system can fill the field information of the database only by searching the path table and directory information without access time to ID 3 Tag of music. Thus, it is possible to make rapid database. Further, since the made database has position information of music and additional information that is necessary for playing by classification, only one time random access makes it possible to play music after completion of classification.

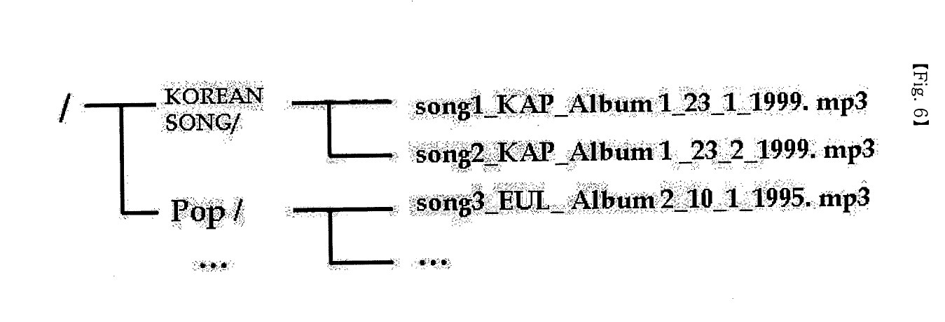

FIG. 6 shows an example of directory structure wherein the field value of database is inserted to file name according to another embodiment.

The example shown in FIG. 6 is a directory structure which is made using long file name by extension of ISO-9660 file system. Music under each directory indicates additional information such as title of music, singer, album name, genre, classification number and year of making.

The playing system recognizes and reads the position of path table by reading PVD of CD to recognize the directory structure of CD. Further, the system can read the file name in directory by reading each directory recording. At that time, database is structured in memory by field value information of the database included in the file name and the position information of the file in directory recording. By use of the database, the files are played by classification according to the user's request.

In this way, since the playing system has the database for playing by classification only with ISO-9660 path table and directory information, it is possible to save time for obtaining additional information regarding all of audio data by accessing and comparing directly to each audio data.

Background processing makes it also possible to make the database in memory of playing system.

When CD is inserted to a playing system for the first time, the playing system recognizes directory structure using PVD and path table, thereafter performing reading and classifying files while entering user input waiting mode.

The data transmission rate that is necessary for playing the file the user selects is 16 Kbyte/sec for a file which is encoded by 128 Kbps. Thus, if the data transfer rate of playing apparatus is about 150 Kbyte/sec (1×Max), the database can be made by use of time during which the remaining 134 Kbyte/sec can be transferred. By the same way, if the data transfer rate of the playing system is 2×Max, the database can be made by use of the time during which 284 Kbyte/sec can be transferred. This is referred to as “background processing.”

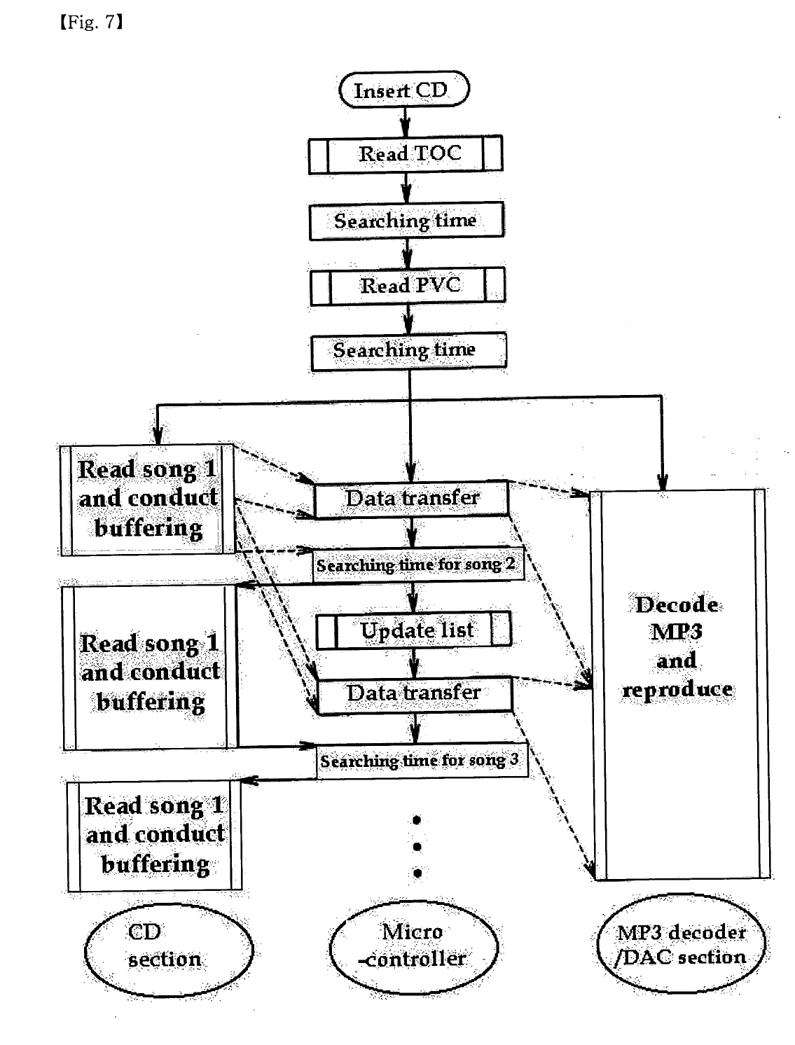

FIG. 7 shows the background processing for making database in memory of a playing system.

In FIG. 7, CD, micro-controller and MP3 decoder simultaneously operates. The CD reads music 1 and buffers it. The micro-controller sends the buffered data, thereafter searching music 2 and reading ID3 Tag to classify it. Then, the controller reads music 1 again and buffers it. These operations are continuously performed while music 3 is read and is classified. Thus, it is possible that the audio data is played by additional information when the audio data is played by classification after whole databases are made.

As described in the above, according to the present invention, searching by field constituting database since the database regarding additional information of audio data recorded in digital audio recording media and regarding position information of audio data. Further, there is advantage that a user can rapidly find a wanted music and play the music due to the position information.

Further, if the database that is necessary for providing playing function by classification is recorded in directory name or file name when the database is obtained from CD-ROM (or digital recording media), the playing system can obtain all of the necessary information for the database only by reading directory recording. Thus, the present invention can save the time for searching each file, compared to the conventional way. Therefore, the playing system according to the present invention quickly responses to the user's request of displaying by classification and playing.

### INDUSTRIAL APPLICABILITY

According to the present invention, since the index information is inserted when digital audio data is recorded in a recording media and since the index information can be used when the digital audio data is searched and played, the search and play can be accelerated.

According to the present invention, when the user wishes to search the digital audio data by use of keyword of additional information of the digital audio data, playing apparatus (200) only has to read directory information reading area (403,409) of the recording media. There is no need to access to even data recording area (415). Thus, the searching time for digital audio data can be considerably reduced.

Further, the present invention provides method, apparatus, and program that convert digital audio data that is recorded in CD by conventional CD audio format to FIF format in accordance with the present invention. In the recording media which is converted to FIF format by the present invention, it is possible to search audio data by keywords of the additional information, but this is impossible for the conventional CD audio format. In addition, data search by keywords of the additional information can be rapidly performed.

1. Method for making database for use in searching digital audio data files from a first recording media,
said first recording media having directory information recording area where information regarding directory is recorded and data recording area where file data is recorded according to information regarding sub file of the directory recorded in said directory information recording area,
said digital audio data files including file name fields which are recorded in said directory information recording area, data fields and additional information tag field which are recorded in said data recording area;
said method comprising (a) step for making directory database which is constituted by fields including name of said directory and recording position of said directory in said directory information recording area, for all directories recorded in said directory information recording area;
(b) step for making file database which is constituted by fields including name of sub file and position in which said sub file is recorded in said data recording area by accessing said recording position in said directory information recording area, for all directories recorded in said directory database;
(c) step for recording index information as field of said file database, said index information being used as keyword when said digital audio data file is searched.

2. The method according to claim 1, wherein said index information that is used as keyword when said digital audio data file is searched is recorded in said directory information recording area of said first recording media, and wherein said step for recording index information includes a step for accessing the recording position of said directory information recording area, reading said index information and recording said index information as field of said file database.

3. The method according to claim 1, further comprising step for making index information database which is constituted by fields including said index information and total number of files corresponding to said index information.

4. Method for making database for use in searching digital audio data files from first recording media and recording said database in second recording media,
said first recording media having directory information recording area where information regarding directory is recorded and data recording area where file data is recorded according to information regarding sub file of the directory recorded in said directory information recording area,
said digital audio data files including file name fields which are recorded in said directory information recording area, data fields and additional information tag field which are recorded in said data recording area;
said method comprising (a) step for making directory database which is constituted by fields including name of said directory and recording position of said directory in said directory information recording area, for all directories recorded in said directory information recording area and recording said directory database in said second recording media;
(b) step for making file database which is constituted by fields including name of sub file and position in which said sub file is recorded in said data recording area by accessing said recording position in said directory information recording area, for all directories recorded in said directory database and recording said file database in said second recording media;
(c) step for inserting index information as field of said file database to said file database, said index information being used as keyword when said digital audio data file is searched and recording said it in said second recording media.

5. The method according to claim 4, wherein said index information that is used as keyword when said digital audio data file is searched is recorded in said directory information recording area of said first recording media, and wherein said step for recording index information includes a step for accessing the recording position of said directory information recording area, reading said index information, inserting said index information as field of said file database to said file database and recording said index information in said second recording media.

6. The method according to claim 4, further comprising step for making index information database which is constituted by fields including said index information and total number of files corresponding to said index information and recording said index information database in said second recording media.

7. The method according to claim 4, wherein said first recording media further includes disc information recording area in which unique information of said first recording media is recorded;
wherein said method further includes step for judging whether said unique information of said first recording media read out by accessing said disc information recording area is already recorded in said second recording media before said step for recording directory database, said step for recording said file database and said step for recording index information; and
step for recording the unique information of said first recording media if the unique information of said first recording media is not recorded in said second recording media,
wherein said step for recording directory database, said step for recording file database and said step for recording index information are performed if the unique information of said first recording media is not already recorded in said second recording media.

8. The method according to claim 7, wherein said step for recording directory database records said directory database in position associated with position where the unique information of said first recording media is recorded;
wherein said step for recording file database records said file database in position associated with position where the unique information of said first recording media or said directory database is recorded.

9. The method according to one of claims 4 to 8, wherein said first recording media is recording media that is not re-recordable and said second recording media is recording media that is re-recordable.

10. Method for searching predetermined digital audio data file from a first recording media,
said first recording media having directory information recording area where information regarding directory is recorded and data recording area where file data is recorded according to information regarding sub file of the directory recorded in said directory information recording area,
said digital audio data files including file name fields which are recorded in said directory information recording area, data fields and additional information tag field which are recorded in said data recording area;
said method comprising (a) step for making directory database which is constituted by fields including name of said directory and recording position of said directory in said directory information recording area, for all directories recorded in said directory information recording area, and recording said directory database in said second recording media;
(b) step for making file database which is constituted by fields including name of sub file and position in which said sub file is recorded in said data recording area by accessing said recording position in said directory information recording area, for all directories recorded in said directory database, and recording said file database in said second recording media;
(c) step for inserting index information as field of said file database to said file database, said index information being used as keyword when said digital audio data file is searched, and recording said it in said second recording media;
(d) step for receiving input of name of digital audio data file to be searched;
(e) step for searching file having same name as said inputted digital audio data to be searched from file name fields of said file database, and reading recording position field corresponding to searched file name field.

11. Method for searching predetermined digital audio data file from a first recording media,
said first recording media having directory information recording area where information regarding directory is recorded and data recording area where file data is recorded according to information regarding sub file of the directory recorded in said directory information recording area,
said digital audio data files including file name fields which are recorded in said directory information recording area, data fields and additional information tag field which are recorded in said data recording area;
said method comprising (a) step for making directory database which is constituted by fields including name of said directory and recording position of said directory in said directory information recording area, for all directories recorded in said directory information recording area, and recording said directory database in said second recording media;
(b) step for making file database which is constituted by fields including name of sub file and position in which said sub file is recorded in said data recording area by accessing said recording position in said directory information recording area, for all directories recorded in said directory database, and recording said file database in said second recording media;
(c) step for inserting index information as field of said file database to said file database, said index information being used as keyword when said digital audio data file is searched, and recording said it in said second recording media;
(d) step for receiving input of name of digital audio data file to be searched;
(e) step for searching file having index information conforming to said inputted index information to be searched by accessing said file database.

12. The method according to claim 11, further comprising step for making index information database which is constituted by field including index information total number of files corresponding to said index information, and recording said database in said second recording media,
wherein said step for searching file is continuously performed until total number of searched files conforms to total number of index information recorded in said index information database.

13. Computer-readable recording media where computer-executable program for making database for searching digital audio data files from first recording media, is recorded,
said first recording media having directory information recording area where information regarding directory is recorded and data recording area where file data is recorded according to information regarding sub file of the directory recorded in said directory information recording area,
said digital audio data files including file name fields which are recorded in said directory information recording area, data fields and additional information tag field which are recorded in said data recording area;
said program comprising (a) step for making directory database which is constituted by fields including name of said directory and recording position of said directory in said directory information recording area, for all directories recorded in said directory information recording area;
(b) step for making file database which is constituted by fields including name of sub file and position in which said sub file is recorded in said data recording area by accessing said recording position in said directory information recording area, for all directories recorded in said directory database;
(c) step for recording index information as field of said file database, said index information being used as keyword when said digital audio data file is searched.

14. Computer-readable recording media where computer-executable program for making database for searching digital audio data files from first recording media and recording said database in second recording media, is recorded,
said first recording media having directory information recording area where information regarding directory is recorded and data recording area where file data is recorded according to information regarding sub file of the directory recorded in said directory information recording area,
said digital audio data files including file name fields which are recorded in said directory information recording area, data fields and additional information tag field which are recorded in said data recording area;
said program comprising (a) step for making directory database which is constituted by fields including name of said directory and recording position of said directory in said directory information recording area, for all directories recorded in said directory information recording area, and recording said directory database in said second recording media;
(b) step for making file database which is constituted by fields including name of sub file and position in which said sub file is recorded in said data recording area by accessing said recording position in said directory information recording area, for all directories recorded in said directory database, and recording said file database in said second recording media;
(c) step for inserting index information as field of said file database to said file database, said index information being used as keyword when said digital audio data file is searched and recording said it in said second recording media.

15. Computer-readable recording media where computer-executable program for searching predetermined digital audio data files from first recording media, is recorded,
said first recording media having directory information recording area where information regarding directory is recorded and data recording area where file data is recorded according to information regarding sub file of the directory recorded in said directory information recording area,
said digital audio data files including file name fields which are recorded in said directory information recording area, data fields and additional information tag field which are recorded in said data recording area;
said program comprising (a) step for making directory database which is constituted by fields including name of said directory and recording position of said directory in said directory information recording area, for all directories recorded in said directory information recording area, and recording said directory database in said second recording media;
(b) step for making file database which is constituted by fields including name of sub file and position in which said sub file is recorded in said data recording area by accessing said recording position in said directory information recording area, for all directories recorded in said directory database, and recording said file database in said second recording media;
(c) step for inserting index information as field of said file database to said file database, said index information being used as keyword when said digital audio data file is searched, and recording said it in said second recording media;
(d) step for receiving input of name of digital audio data file to be searched;
(e) step for searching file having same name as said inputted digital audio data to be searched from file name fields of said file database, and reading recording position field corresponding to searched file name field.

16. Computer-readable recording media where computer-executable program for searching predetermined digital audio data files from first recording media, is recorded,
said first recording media having directory information recording area where information regarding directory is recorded and data recording area where file data is recorded according to information regarding sub file of the directory recorded in said directory information recording area,
said digital audio data files including file name fields which are recorded in said directory information recording area, data fields and additional information tag field which are recorded in said data recording area;
said program comprising (a) step for making directory database which is constituted by fields including name of said directory and recording position of said directory in said directory information recording area, for all directories recorded in said directory information recording area, and recording said directory database in said second recording media;
(b) step for making file database which is constituted by fields including name of sub file and position in which said sub file is recorded in said data recording area by accessing said recording position in said directory information recording area, for all directories recorded in said directory database, and recording said file database in said second recording media;
(c) step for inserting index information as field of said file database to said file database, said index information being used as keyword when said digital audio data file is searched, and recording said it in said second recording media;
(d) step for receiving input of name of digital audio data file to be searched;
(e) step for searching file having index information conforming to said inputted index information to be searched by accessing said file database.
